(19) United States
(12) Patent Application Publication
(10) Pub. No.: US 2010/0273081 A1
(43) Pub. Date: Oct. 28, 2010

(54) FUEL CELL SYSTEM AND MOVING BODY

(75) Inventor: Norimasa Ishikawa, Asahikawa-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi (JP)

(21) Appl. No.: 12/747,356

(22) PCT Filed: Nov. 20, 2008
(86) PCT No.: PCT/JP2008/071099

§ 371 Date: Jun. 10, 2010

(30) Foreign Application Priority Data
Dec. 11, 2007 (JP) 2007-320159

(51) Int. Cl. H01M 8/04

(52) U.S. Cl. 429/443

(57) ABSTRACT

The amount of a reactant gas supplied to a fuel cell is properly maintained even in the case where a failure of reactant gas supply takes place in the middle of a drive cycle of a valve device. Provided is a fuel cell system including: a fuel cell; a gas supply flow path for supplying the reactant gas to the fuel cell; a valve device which is provided in the gas supply flow path and driven at a predetermined drive cycle; a controller which controls the drive of the valve device such that the reactant gas supplied to the fuel cell reaches a target gas state; and a sensor which measures the gas state of the reactant gas on a downstream side of the valve device, wherein the controller drives the valve device independently of the predetermined drive cycle in the case where the controller detects that the difference between the target gas state and a gas state measured by the sensor has exceeded a predetermined value.

### TECHNICAL FIELD

The present invention relates to a fuel cell system and a moving body and more particularly to a technique for controlling the supply of a reactant gas to a fuel cell.

### BACKGROUND ART

In recent years, there has been proposed and put to practical use a fuel cell system provided with a fuel cell which receives supplied reactant gases (a fuel gas and an oxidizing gas) and generates electric power. The fuel cell system has a fuel supply flow path for passing a hydrogen gas supplied from a fuel supply source, such as a hydrogen tank, to the fuel cell and an air supply flow path for passing air in the atmosphere drawn in by a compressor or the like to the fuel cell.

To maintain a good condition for generating electric power in the fuel cell, it is important to detect a reactant gas supply failure in gas supply systems, including the fuel supply flow path and the air supply flow path, and to promptly take measures for correcting the failure. As this type of a fuel cell system, one has been proposed in, for example, patent document 1. The fuel cell system has a gas supply system provided with an injector to detect a failure in the gas supply system on the basis of a target operational amount of the injector and a detected physical quantity of the gas supply system, and then sets the opening degree and the release time of the valve element of the injector.

[Patent Document 1]

Japanese Patent Application Laid-Open No. 2007-165237

### DISCLOSURE OF THE INVENTION

### Problem to be Solved by the Invention

However, in the aforesaid fuel cell system, the injector jets out a reactant gas at a predetermined drive cycle, and if a gas leak takes place on the downstream side of the gas supply system during a drive cycle, then the target operational amount cannot be maintained. In this case, an insufficient amount of the reactant gas is supplied to the fuel cell, thus resulting in a failure to maintain the good condition for generating electric power in the fuel cell.

Accordingly, the present invention has been made in view of the problem with the conventional art, and it is an object of the invention to provide a fuel cell system capable of properly maintaining the amount of a reactant gas supplied to a fuel cell even if a reactant gas supply failure takes place during a drive cycle of a valve device.

### Means for Solving the Problem

To solve the aforesaid problem, the present invention adopts the following means. A fuel cell system includes a fuel cell; a gas supply flow path for supplying a reactant gas to the fuel cell; a valve device which is provided in the gas supply flow path and driven at a predetermined drive cycle; a controller which controls the drive of the valve device such that the reactant gas supplied to the fuel cell reaches a target gas state; and a sensor which measures the gas state of a reactant gas on the downstream side of the valve device, wherein the controller drives the valve device independently of the predetermined drive cycle in the case where the controller detects that the difference between the target gas state and a gas state measured by the sensor has exceeded a predetermined value.

With this arrangement, even if the difference between a target gas state and a measured gas state reaches a predetermined value or more during a drive cycle of the valve device (typically inadequate supply of a gas due to a gas leak or the like), the controller drives the valve device independently of the predetermined drive cycle, thus making it possible to properly maintain the amount of the reactant gas supplied to the fuel cell.

In the present description, the term “gas state” means the state of a gas indicated by a flow rate, a pressure, a temperature, a molar concentration and the like.

Further, in the aforesaid construction, the controller may enable measurement by the sensor after predetermined time elapses from the instant the valve of the valve device is opened.

With this arrangement, a reactant gas state of the gas supply flow path after the predetermined time elapses can be measured, making it possible to prevent the gas state from being measured in an unstable state immediately after the valve is opened. This permits proper detection of a failure of the supply of the reactant gas.

Further, in the aforesaid construction, the controller may have a predetermined arithmetic cycle, and the controller may detect whether the difference between the target gas state and the gas state measured by the sensor exceeds a predetermined value at an arithmetic cycle following the elapse of the predetermined time.

With this arrangement, a reactant gas supply failure can be detected at the predetermined arithmetic cycle.

In the aforesaid construction, the predetermined time may be the time required for the gas state on the downstream side of the valve device to stabilize after the valve of the valve device is opened.

With this arrangement, a reactant gas state of the gas supply flow path can be measured in a state wherein the gas state on the downstream side of the valve device is stable, making it possible to prevent the gas state from being measured in an unstable state. This permits proper detection of a failure of the supply of the reactant gas.

Further, in the aforesaid construction, the gas state may be the gas pressure of the reactant gas and the sensor may be a pressure sensor.

With this arrangement, a reactant gas supply failure can be detected by detecting the gas pressure of the reactant gas.

In the aforesaid construction, the valve device may be an injector.

An injector is highly responsive and capable of responding to an irregular and subtle drive command during a drive cycle, making the injector extremely usefully applied to the present invention and allowing the amount of the reactant gas supplied to the fuel cell to be maintained further properly.

The injector in the present description is typically composed of an electromagnetically driven on-off valve capable of regulating the gas state by directly driving the valve element with an electromagnetic drive power at a predetermined drive cycle to move the valve element away from a valve seat.

A moving body in accordance with the present invention has the aforesaid fuel cell system.

This arrangement makes it possible to provide a moving body which exhibits high responsiveness to an output request (e.g., the opening degree or like of an accelerator pedal in the case of a vehicle), since the moving body is provided with the fuel cell system which further properly maintains the amount of a reactant gas supplied to the fuel cell.

### Effect of the Invention

The present invention makes it possible to provide a fuel cell system capable of properly maintaining the amount of a reactant gas supplied to a fuel cell even in the case where a reactant gas supply failure takes place during a drive cycle of a valve device.

### BRIEF DESCRIPTION OF THE DRAWINGS

FIG. 1 It is a block diagram of a fuel cell system according to an embodiment of the present invention.

FIG. 2 It is a functional block diagram related to the control of an injector of the fuel cell system according to the embodiment.

FIG. 3 It is a flowchart of asynchronous injection control according to the embodiment.

FIG. 4 It is a timing chart illustrating an example of timings of pressure measurement and asynchronous injection according to the embodiment.

FIG. 5 It is a timing chart illustrating another timing example of the pressure measurement according to the embodiment.

FIG. 6 It is a set of charts illustrating time-dependent changes in the downstream pressure of the injector in the case where the asynchronous injection control according to the embodiment is conducted.

FIG. 7 It is a set of charts illustrating time-dependent changes in the downstream pressure of the injector in the case where conventional injection control according to a comparative example is conducted.

### DESCRIPTION OF REFERENCE NUMERALS

1 . . . Fuel cell system;
2 . . . Oxidizing gas piping system;
3 . . . Hydrogen gas piping system;
4 . . . Controller;
10 . . . Fuel cell;
11 . . . PCU;
12 . . . Traction motor;
13 . . . Current sensor;
20 . . . Humidifier;
21 . . . Oxidizing gas supply flow path;
22 . . . Oxidizing gas exhaust flow path;
23 . . . Exhaust flow path;
24 . . . Compressor;
25 . . . Cathode pressure sensor;
26 . . . Backpressure valve;
27 . . . Step motor;
30 . . . Hydrogen tank;
31 . . . Hydrogen supply flow path (Fuel gas supply means);
32 . . . Circulation flow path;
33 . . . Shutoff valve;
34 . . . Regulator;
35 . . . Injector;
36 . . . Gas-liquid separator;
37 . . . Purge valve;
38 . . . Exhaust flow path;
39 . . . Hydrogen pump;
40 . . . Diluter (Diluting means);
41 . . . Upstream pressure sensor of injector;
42 . . . Temperature sensor;
43 . . . Anode pressure sensor

### BEST MODE FOR CARRYING OUT THE INVENTION

Referring to the attached drawings, a fuel cell system according to an embodiment of the present invention will be described in the following order. In the present embodiment, an example in which the present invention has been applied to an in-vehicle power generating system of a fuel cell hybrid vehicle (a moving body) will be described. In the drawings, the same reference numerals are assigned to the same components.
1. General construction of the fuel cell system according to the embodiment of the present invention
2. Asynchronous injection control of an injector of the fuel cell system
3. Modification example of the fuel cell system

### 1. General Construction of the Fuel Cell System According to the Embodiment of the Present Invention

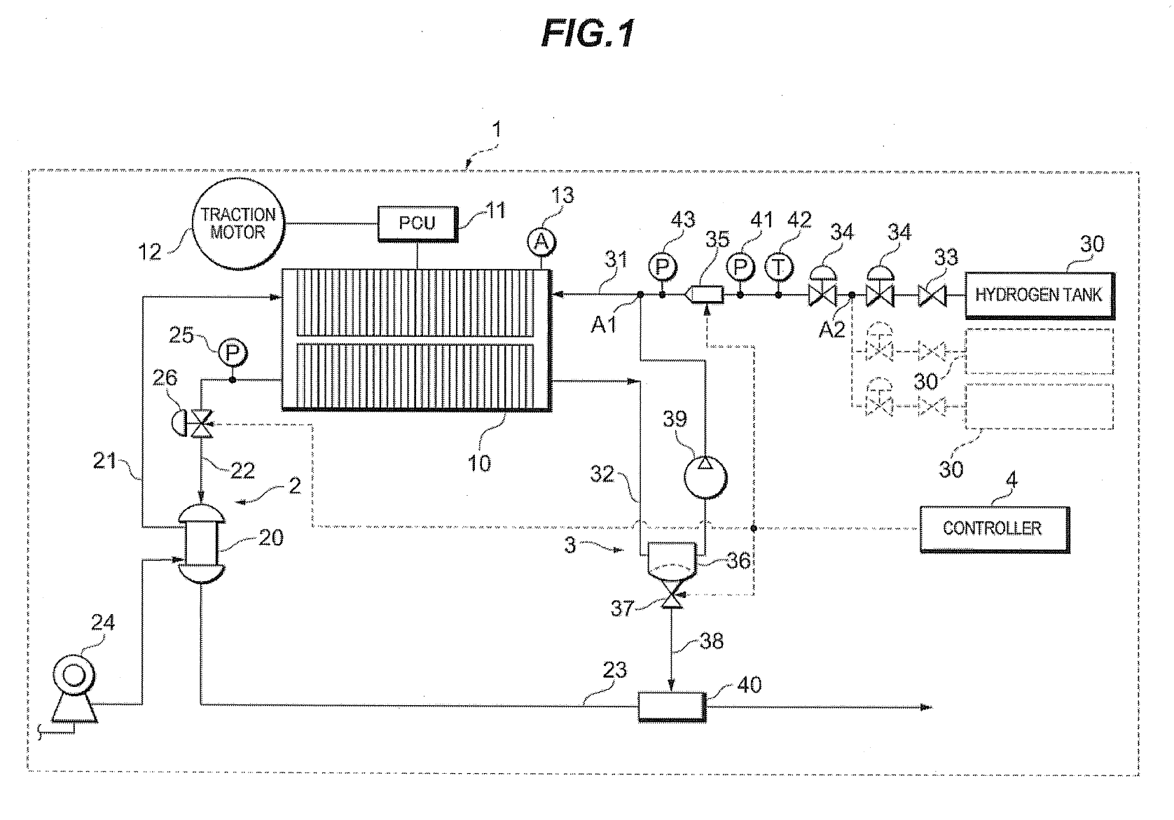

First, referring to FIG. 1, the general construction of a fuel cell system 1 according to the embodiment of the present invention will be described. In the present embodiment, an example in which the present invention has been applied to an in-vehicle power generating system of a fuel cell hybrid vehicle (a moving body) will be described.

As illustrated in FIG. 1, the fuel cell system 1 according to the present embodiment is primarily provided with a fuel cell 10 which receives supplied reactant gases (an oxidizing gas and a fuel gas) and generates electric power, an oxidizing gas piping system 2 which supplies air serving as the oxidizing gas to the fuel cell 10, a hydrogen gas piping system 3 which supplies hydrogen as the fuel gas to the fuel cell 10, and a controller 4 which integrally controls the entire system.

The fuel cell 10 has a stack structure in which a predetermined number of single cells receiving supplied reactant gases to generate electric power is stacked. Each of the single cells has an electrolyte membrane formed of an ion-exchange membrane and a pair of an anode and a cathode sandwiching the electrolyte membrane from both surfaces, although none of these components are illustrated.

The oxidizing gas (air) of a predetermined pressure is supplied to the cathode from the oxidizing gas piping system 2, while a hydrogen gas of a predetermined pressure is supplied to the anode from the hydrogen gas piping system 3. The electrochemical reaction of the two gases produces an electromotive force of each single cell.

The electric power generated by the fuel cell 10 is supplied to the PCU (Power Control Unit) 11. The PCU 11 is provided with an inverter, a DC-DC converter and the like disposed between the fuel cell 10 and a traction motor 12. Further, the fuel cell 10 has a current sensor 13 which detects current during power generation.

The oxidizing gas piping system 2 has an oxidizing gas supply flow path 21 through which the oxidizing gas (air) humidified by a humidifier 20 is supplied to the fuel cell 10, an oxidizing gas exhaust flow path 22 which guides an oxidizing off-gas discharged from the fuel cell 10 to the humidifier 20, and an exhaust flow path 23 for guiding the oxidizing off-gas from the humidifier 20 to the outside via a diluter 40. The oxidizing gas supply flow path 21 is provided with a compressor 24 which takes in air from the atmosphere and pressure-feeds the introduced air to the humidifier 20. The oxidizing gas exhaust flow path 22 includes a cathode pressure sensor 25 for detecting the pressure of the oxidizing gas in the fuel cell 10 and a backpressure valve 26 which regulates the flow rate of the oxidizing off-gas according to a change in a primary pressure thereby to regulate the pressure of the oxidizing gas in the fuel cell 10. The backpressure valve 26 is formed of, for example, a butterfly valve.

The hydrogen gas piping system 3 is provided with a hydrogen tank 30 serving as a fuel supply source storing a high-pressure hydrogen gas, a hydrogen supply flow path 31 for supplying the hydrogen gas in the hydrogen tank 30 to the fuel cell 10, and a circulation flow path 32 for returning the hydrogen off-gas exhausted from the fuel cell 10 back to the hydrogen supply flow path 31. In place of the hydrogen tank 30, a reformer which generates a hydrogen-rich reformed gas from a hydrocarbon-based fuel and a high-pressure gas tank which stores, under a high pressure, the reformed gas produced by the reformer may be adopted as the fuel supply source. Alternatively, a tank having a hydrogen storing alloy may be adopted as the fuel supply source.

The hydrogen supply flow path 31 is provided with a shutoff valve 33 which cuts off or enables the supply of the hydrogen gas from the hydrogen tank 30, a regulator 34 which regulates the pressure of the hydrogen gas, and an injector 35. Further, a pressure sensor 41 and a temperature sensor 42 on the upstream side of the injector for detecting the pressure and the temperature of the hydrogen gas in the hydrogen supply flow path 31 are provided on the upstream side of the injector 35. Further, an anode pressure sensor 43 for detecting the pressure of the hydrogen gas in the fuel cell 10 is provided between the downstream side of the injector 35 and the upstream side of a merging portion A1 of the hydrogen supply flow path 31 and the circulation flow path 32.

The regulator 34 is a device which regulates the pressure on the upstream side thereof (the primary pressure) to a preset secondary pressure. In the present embodiment, a mechanical pressure reducing valve for reducing the primary pressure is adopted as the regulator 34. As the construction of the mechanical pressure reducing valve, a publicly known construction may be used. The publicly known construction includes an enclosure formed of a backpressure chamber and a pressure-regulating chamber, which are separated by a diaphragm, the primary pressure being reduced to a predetermined pressure in the pressure-regulating chamber by a backpressure in the backpressure chamber so as to obtain the secondary pressure. In the present embodiment, as illustrated in FIG. 1, two regulators 34 are disposed on the upstream side of the injector 35 to reduce the pressure on the upstream side of the injector 35.

The injector 35 is an electromagnetically driven on-off valve capable of adjusting a gas flow rate and a gas pressure by directly driving the valve element with an electromagnetic drive force at a predetermined drive cycle to move the valve element away from a valve seat. The injector 35 is provided with a valve seat having an injection orifice through which a gas fuel, such as a hydrogen gas, is injected, a nozzle body which supplies and guides the gas fuel to the injection orifice, and the valve element which is movably accommodated and retained in the axial direction (in the direction in which the gas flows) with respective to the nozzle body and which opens and closes the injection orifice. In the present embodiment, the valve element of the injector 35 is driven by a solenoid, which is an electromagnetically driven device, and the opening area of the injection orifice can be changed in two steps or multiple steps by turning on/off a pulsing excitation current supplied to the solenoid. The gas injection time and the gas injection timing of the injector 35 are controlled by control signals output from the controller 4 thereby to controlling the flow rate and the pressure of the hydrogen gas with high accuracy. The injector 35 is adapted to directly drive the valve element and the valve seat by an electromagnetic drive force to open/close the valve element and the valve seat. The drive cycle of the injector permits control up to a high-response range, exhibiting high responsiveness. In the present embodiment, the injector is characteristically driven independently of the predetermined drive cycle, the control of which will be discussed hereinafter.

In the present embodiment, as illustrated in FIG. 1, the injector 35 is disposed on the upstream side from the merging portion A1 of the hydrogen supply flow path 31 and the circulation flow path 32. Further, in the case where a plurality of hydrogen tanks 30 is adopted as the fuel supply source, as indicated by the dashed lines in FIG. 1, the injector 35 is disposed on the downstream side from a portion where the hydrogen gases supplied from the hydrogen tanks 30 merge (a hydrogen gas merging portion A2).

The exhaust flow path 38 is connected to the circulation flow path 32 via the gas-liquid separator 36 and the purge valve 37. The gas-liquid separator 36 recovers moisture from the hydrogen off-gas. The purge valve 37 is actuated in response to a command from the controller 4 to discharge (purge) the moisture recovered by the gas-liquid separator 36 and the hydrogen off-gas (fuel off-gas) containing impurities in the circulation flow path 32. The circulation flow path 32 is provided with a hydrogen pump 39 which pressurizes the hydrogen off-gas in the circulation flow path 32 and feeds the pressurized hydrogen off-gas to the hydrogen supply flow path 31.

The diluter 40 serving as the diluting means dilutes the hydrogen off-gas, which is exhausted through the purge valve 37 and the exhaust flow path 38, by the oxidizing off-gas exhausted through the exhaust flow path 23 and then discharges the diluted gas to the outside.

The controller 4 detects the manipulated variable of an acceleration operating member (an accelerator pedal or the like) provided in a vehicle and controls the operation of various types of devices in the system upon receipt of control information, such as an acceleration request value (e.g., a required amount of electric power to be generated, which is received from a load device, such as the traction motor 12). The load device is a generic term referring to auxiliary devices necessary to operate the fuel cell 10 (e.g., the compressor 24, the hydrogen pump 39, and the motor of a cooling pump), the actuators used with various types of devices (a transmission, a wheel controller, a steering device, a suspension device, and the like) involved in the travel of a vehicle, and power consuming devices, including an air conditioning device (an air conditioner), lighting, and audio equipment, in a driver compartment, in addition to the traction motor 12.

The controller 4 is constituted of a computer system, which is not shown. The computer system is provided primarily with a CPU, a ROM, a RAM, an HDD, an input/output interface, and a display. Various types of control programs recorded in the ROM are read and executed by the CPU, thereby performing various types of control operations.

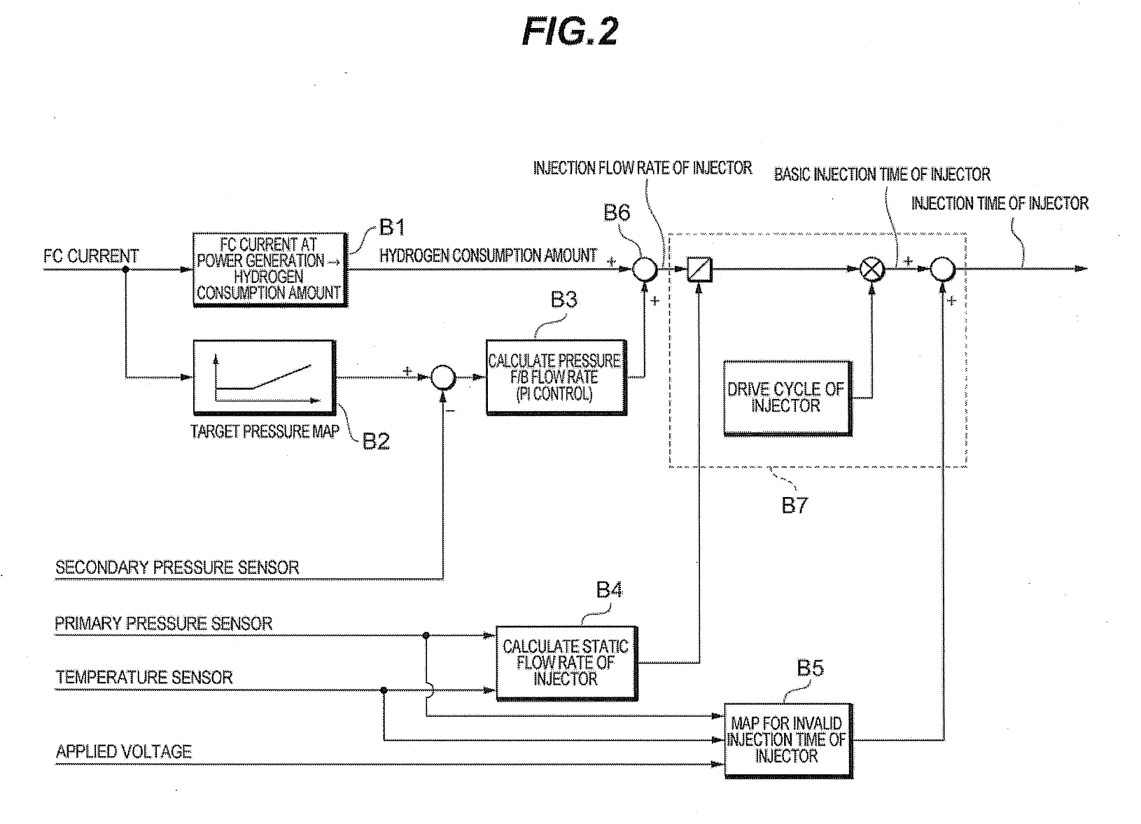

More specifically, the controller 4 calculates the supply amounts of the oxidizing gas and the hydrogen gas required by the fuel cell 10 on the basis of the operating condition of the fuel cell 10 (e.g., the current value at the time of power generation in the fuel cell 10 detected by the current sensor 13). Then, the controller 4 controls the backpressure valve 26 and the injector 35 to supply the oxidizing gas and the hydrogen gas of the desired flow rates and pressures to the fuel cell 10. Referring to FIG. 2, the control function of the injector 35 by the controller 4 will be described below in detail. Here, FIG. 2 is a functional block diagram related to the control of the injector 35 according to the embodiment of the present invention.

As illustrated in FIG. 2, the controller 4 calculates the amount of the hydrogen gas consumed by the fuel cell 10 (hereinafter referred to as “the hydrogen consumption amount”) on the basis of the operating condition of the fuel cell 10 (the current value at the time of power generation in the fuel cell 10 detected by the current sensor 13)(a fuel consumption amount calculating function: B1). In the present embodiment, the hydrogen consumption amount is calculated and updated for each arithmetic cycle of the controller 4 by using a specific arithmetic expression indicating the relationship between a current value and a hydrogen consumption amount of the fuel cell 10.

Further, the controller 4 calculates the target pressure value of the hydrogen gas at a downstream position of the injector 35 (the target pressure of the gas supplied to the fuel cell 10) on the basis of the operating condition of the fuel cell 10 (the current value at the time of power generation in the fuel cell 10 detected by the current sensor 13) (a function for calculating a target pressure value: B2). In the present embodiment, the target pressure value at the position where the secondary pressure sensor 43 is disposed is calculated and updated for each arithmetic cycle of the controller 4 by using a specific map which represents a relationship between current values and target pressure values of the fuel cell 10.

Further, the controller 4 calculates a feedback correction flow rate on the basis of the difference between the calculated target pressure value and the pressure value (the detected pressure value) at the downstream position of the injector 35, which has been detected by the secondary pressure sensor 43 (a function for calculating a feedback correction flow rate: B3). The feedback correction flow rate is the hydrogen gas flow rate to be added to a hydrogen consumption amount in order to reduce the difference between a target pressure value and a detected pressure value. In the present embodiment, a PI feedback control law is used to calculate and update the feedback correction flow rate for each arithmetic cycle of the controller 4.

Further, the controller 4 calculates the static flow rate of the upstream of the injector 35 on the basis of the gas condition (the pressure of the hydrogen gas detected by the primary pressure sensor 41 and the temperature of the hydrogen gas detected by the temperature sensor 42) of the injector 35 (a function for calculating a static flow rate: B4). In the present embodiment, the static flow rate is calculated and updated for each arithmetic cycle of the controller 4 by using a specific arithmetic expression representing a relationship between the pressure and temperature of the hydrogen gas on the upstream side of the injector 35 and the static flow rate.

Further, the controller 4 calculates the invalid injection time of the injector 35 on the basis of the gas condition (the pressure and the temperature of the hydrogen gas) at the upstream of the injector 35 and an applied voltage (a function for calculating invalid injection time: B5). In the present embodiment, the invalid injection time is calculated and updated for each arithmetic cycle of the controller 4 by using a specific map indicating a relationship among the pressures and temperatures of the hydrogen gas on the upstream side of the injector 35, applied voltages, and invalid injection time.

Further, the controller 4 adds the hydrogen consumption amount and the feedback correction flow rate to calculate the injection flow rate of the injector 35 (a function for calculating the injection flow rate: B6). Then, the controller 4 multiplies the value, which is obtained by dividing the injection flow rate of the injector 35 by the static flow rate, by the drive cycle of the injector 35 thereby to calculate the basic injection time of the injector 35, and also calculates the total injection time of the injector 35 by adding the basic injection time and the invalid injection time (a function for calculating the total injection time: B7). Here, the drive cycle means a stepped (ON/OFF) waveform cycle indicating the ON/OFF state of the injection orifice of the injector 35. In the present embodiment, the drive cycle is set at a fixed value (T₁) by the controller 4.

Then, the controller 4 sends out a control signal for implementing the total injection time of the injector 35 calculated according to the procedure described above to control the gas injection time and the gas injection timing of the injector 35 so as to drive the injector 35 at a predetermined drive cycle. Thus, the flow rate and the pressure of the hydrogen gas supplied to the fuel cell 10 are adjusted.

### 2. Asynchronous Injection Control of the Injector

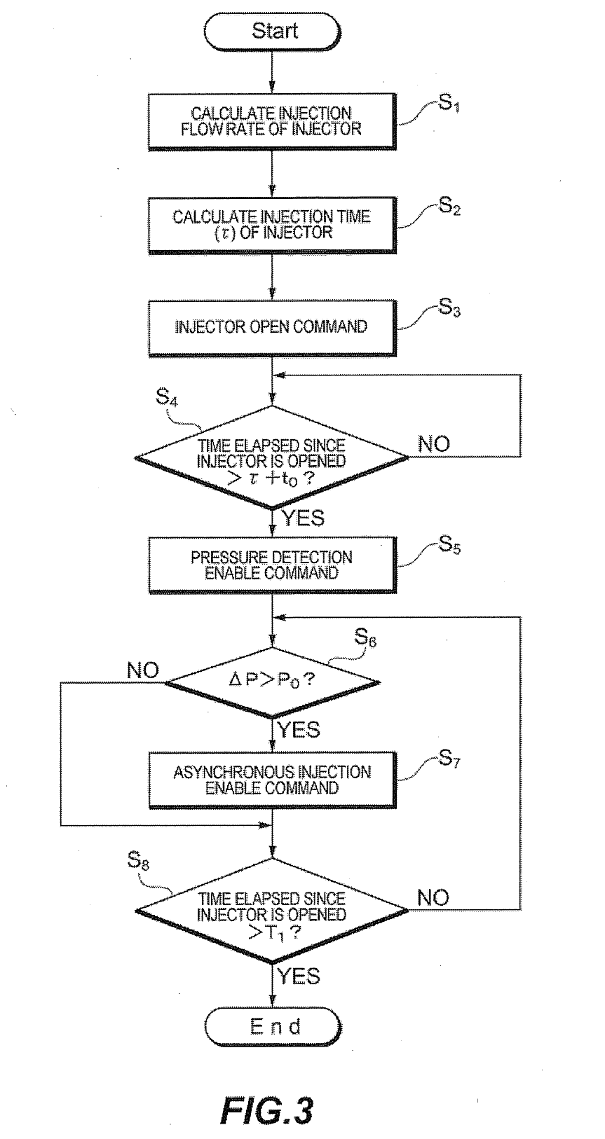

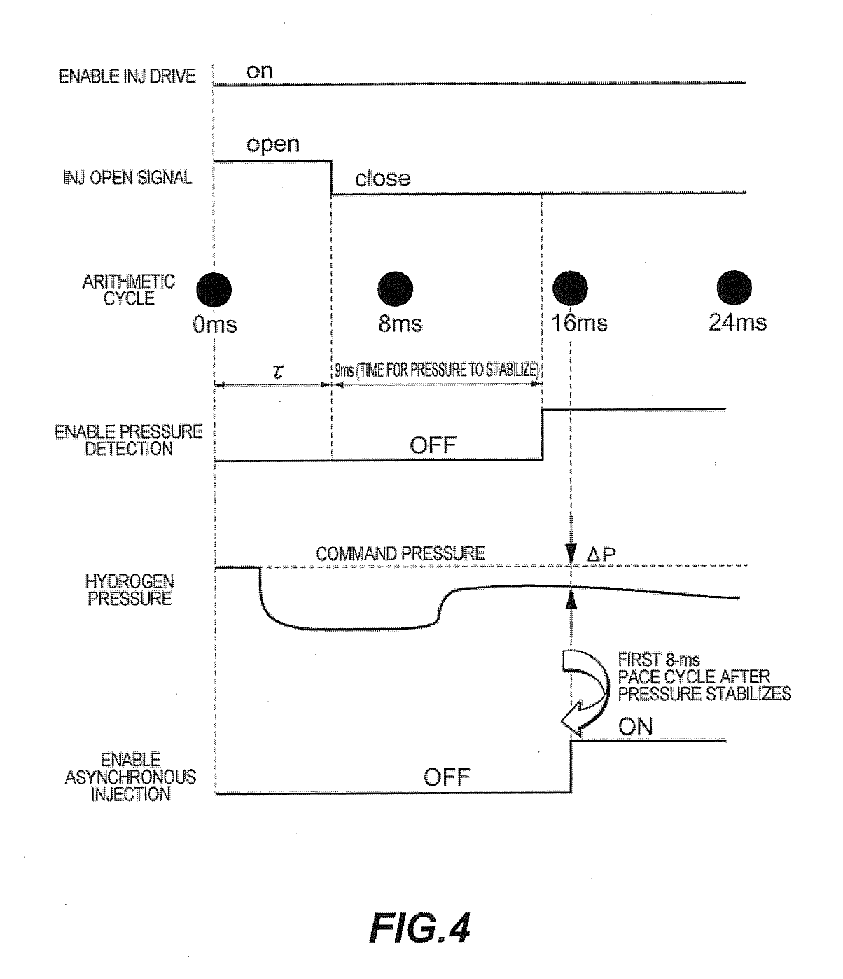

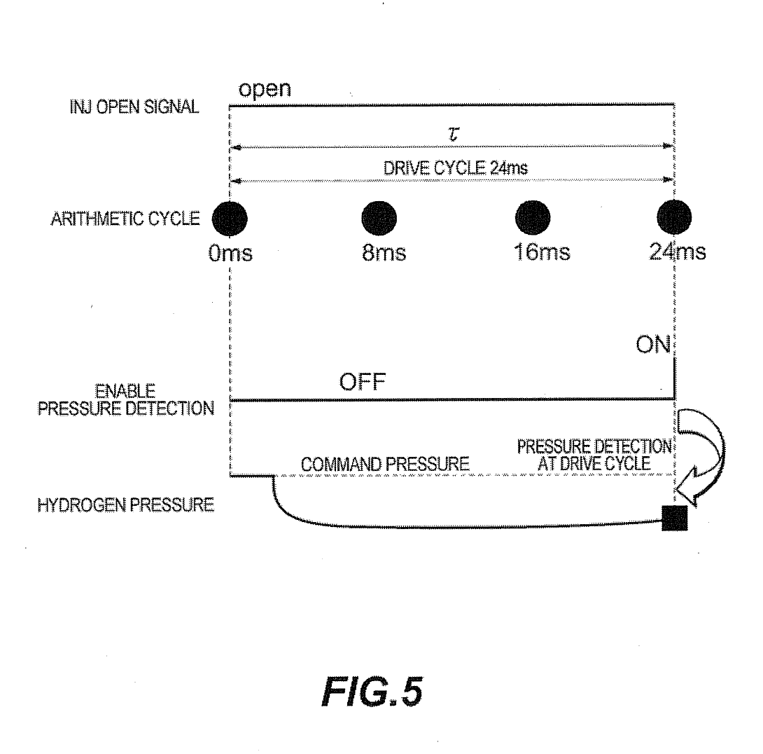

According to the fuel cell system 1 of the present embodiment, the controller 4 detects a failure of the supply of the hydrogen gas to the fuel cell 10 and, in case the supply failure is detected, the controller 4 makes the injector 35 perform injection independently of the aforesaid predetermined drive cycle (hereinafter also referred to as “the asynchronous injection”) thereby to maintain the amount of the hydrogen gas supplied to the fuel cell 10 at a proper amount. The following will explain in detail the control method for the asynchronous injection with reference to FIG. 3 through FIG. 5. Here, FIG. 3 is a flowchart of the asynchronous injection control according to the embodiment of the present invention, FIG. 4 is a timing chart illustrating an example of timings of pressure measurement and asynchronous injection according to the embodiment, and FIG. 5 is a timing chart illustrating another timing example of the pressure measurement according to the embodiment.

As illustrated in FIG. 3, first, the controller 4 calculates the injector injection flow rate (S₁) and also calculates the injector injection time (τ)(S₂). These arithmetic operations are performed by the function for calculating the injection flow rate and the function for calculating the total injection time of the controller 4 described above (refer to FIG. 2), so that the description thereof will be omitted here.

Subsequently, the controller 4 sends out a control signal (a command for opening the injector) to the injector 35 to implement the calculated total injection time of the injector 35 (S₃). This opens the valve of the injector 35, causing the hydrogen gas to flow toward the downstream side of the injector 35 to be supplied to the fuel cell 10. The controller 4 counts the time elapsed from the instant the valve of the injector 35 is opened, and sends out a control signal (a command for closing the injector) to the injector 35 when the injection time (τ) of the injector has passed. This closes the valve of the injector 35, thus stopping the supply of the hydrogen gas to the fuel cell 10.

The controller 4 continues to count the time elapsed from the instant the valve of the injector 35 is opened, and determines whether the time obtained by adding predetermined time t₀ to the injection time (τ) of the injector has passed (=whether time t₀ has passed since the valve of the injector 35 was closed) (S₄). If the time t₀ has passed (YES in S₄), then a pressure detection enable command is sent out to the sensor 31 (S₅). Here, time t₀ indicates the time required for the pressure on the downstream side of the injector 35 to stabilize after the valve of the injector 35 is closed, and the time t₀ in the present embodiment is 9 ms. Upon receipt of the pressure detection command, the pressure sensor 43 measures the pressure on the downstream side of the injector 35 (=the pressure of supply to the fuel cell 10). The measurement is performed using, for example, a four-point moving average or the like.

Subsequently, the controller 4 determines whether a value (ΔP) obtained by subtracting the pressure value measured by the pressure sensor 43 from the calculated target pressure value is larger than a predetermined value (P₀)(S₆). If the controller 4 determines that the value is larger (YES in S₆), then the controller 4 sends out an asynchronous injection enable command to the injector 35 (S₇). If the controller 4 determines that the value is not larger, then the controller 4 proceeds to the next step without issuing the asynchronous injection enable command (S₈). Here, the predetermined value P₀ denotes a permissible control error of the supply pressure that allows a required hydrogen flow rate to be secured without causing deterioration of the fuel cell 10, and the predetermined value P₀ is set to 10 kPa in the present embodiment.

If ΔP is larger than the predetermined value P₀, then it means that an actual pressure has significantly lowered, as compared with a target pressure and that a failure of the supply of the hydrogen gas to the fuel cell 10 (insufficient supply in this case) has taken place. In such a case, the injector 35 is forcibly opened (independently of the predetermined drive cycle) upon receipt of the asynchronous injection enable command from the controller 4. This causes the hydrogen gas to be supplied to the fuel cell 10.

The controller 4 determines whether the open-valve elapsed time of the injector 35 is larger than a drive cycle T₁ (S₈), and if the open-valve elapsed time has not yet reached the drive cycle T₁ (NO in S₈), then the controller 4 returns to the measurement of the pressure (S₆) to continue the step. In other words, it is constantly monitored for a hydrogen gas supply failure until the next drive cycle after the pressure on the downstream side of the injector 35 stabilizes, and if the failure happens, then the injector 35 carries out injection regardless of the drive cycle (asynchronous injection).

The timing examples of the pressure measurement and the asynchronous injection in the flowchart of FIG. 3 will be explained with reference to FIG. 4. As illustrated in FIG. 4, the timing when the pressure detection is enabled (when a pressure detection enable flag switches from OFF to ON) is the timing when the time elapsed from the instant the injector 35 is opened (an INJ drive enable flag is ON or an INJ open signal is open) reaches the time obtained by adding the predetermined time t₀ to the injection time (τ) of the injector. The calculation of the value ΔP and the asynchronous injection (the asynchronous injection enable flag is switched from OFF to ON) are performed from the moment the pressure detection is enabled to the next arithmetic cycle of the controller (16 ms after the injector 35 is opened in the present embodiment). This arrangement makes it possible to detect a hydrogen gas supply failure according to the timing of a predetermined arithmetic cycle.

The aforesaid pressure detection timing applies to the case where the open time (τ) of the injector 35 is sufficiently small, as compared with the drive cycle (T₁) of the injector 35 (specifically, T₁<τ+t₀). However, under an operating condition in which the required flow rate of the hydrogen gas is high and the open time (τ) of the injector 35 is longer than the drive cycle of the injector 35, the pressure detection timing may be set, for example, as illustrated in FIG. 5. More specifically, as illustrated in FIG. 5, the controller 4 may send out the pressure detection enable command to the pressure sensor 43 (switch the pressure detection enable flag from OFF to ON) when the open time reaches the drive cycle even if the injector 35 is not closed.

In the asynchronous injection control, the controller 4 may not carry out learning control, integral control or the like performed for each drive cycle of the injector 35 in order to avoid complicated calculation. Meanwhile, the controller 4 carries out exhaust and drainage control through the purge valve 37 in the same manner as the control for each drive cycle even during the asynchronous injection.

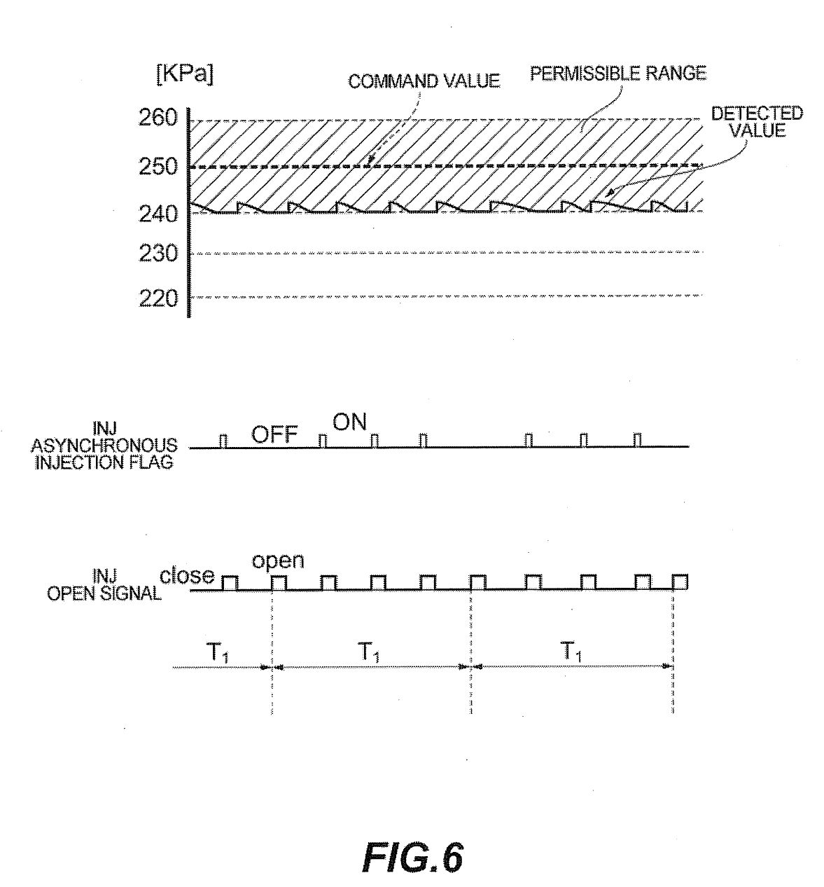

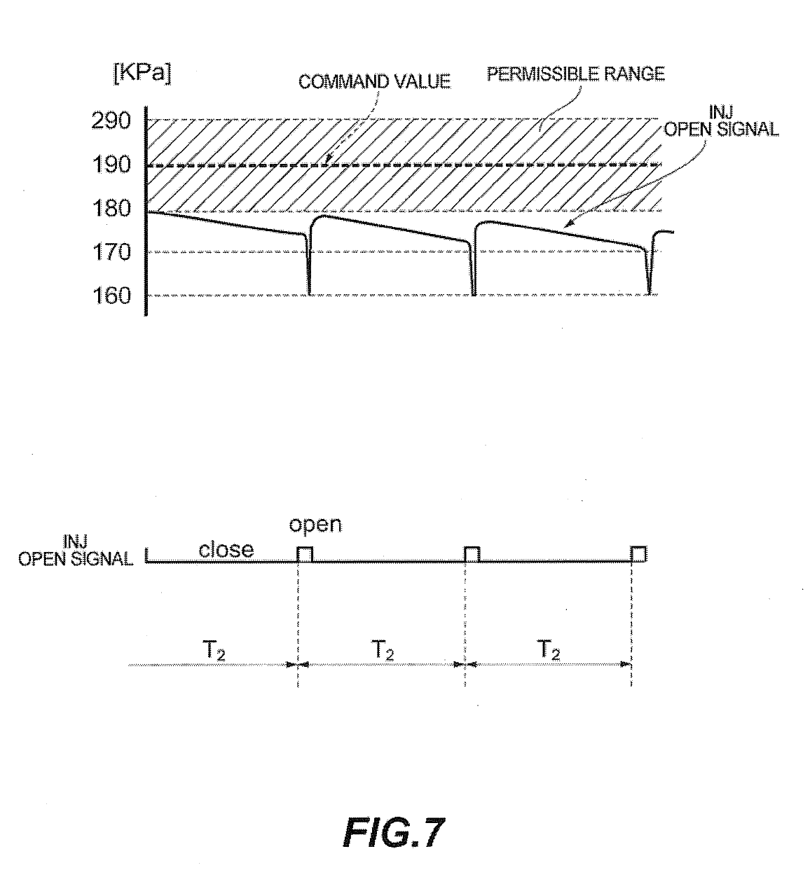

Comparing FIG. 6 and FIG. 7, an effect provided by the asynchronous injection control in accordance with the present invention will now be described. Here, FIG. 6 is a set of charts illustrating time-dependent changes in the downstream pressure of the injector in the case where the asynchronous injection control according to the embodiment of the present invention is conducted, and FIG. 7 is a set of charts illustrating time-dependent changes in the downstream pressure of the injector in the case where conventional injection control according to a comparative example is conducted. Both figures illustrate experimental results of the time-dependent changes of the downstream pressure of the injector when a simulated leakage takes place in the purge valve.

As illustrated in FIG. 6, when the asynchronous injection control is carried out, in the case where the leakage of the hydrogen gas from the purge valve takes place during a drive cycle, the INJ open signal is switched to open so as to supply the hydrogen gas even in the middle of a drive cycle. Hence, the detected value of the downstream pressure of the injector always remains within a permissible range from a command value to 10 KPa.

In contrast thereto, according to the conventional injection control illustrated in FIG. 7, the asynchronous injection is not carried out and the INJ open signal simply switches to open for every drive cycle. Therefore, the detected value of the downstream pressure of the injector is considerably lower than the permissible range especially during the drive cycle.

As described above, the fuel cell system 1 according to the embodiment of the present invention, the controller 4 drives the injector 35 independently of the drive cycle, thus making it possible to maintain the amount of the hydrogen gas supplied to the fuel cell 10 always within a desired range.

### 3. Modification Example of the Fuel Cell System According to the Embodiment of the Present Invention

While an embodiment of the present invention has been described above, it is to be understood that the invention is not limited to the disclosed embodiment of the present invention and, thus, variations that do not depart from the gist of the invention are intended to be within the scope of the invention. For example, the following modifications are possible.

In addition, the aforesaid embodiment has disclosed the example wherein the injector 35 is used as the valve device in the present invention. However, the valve device is not limited to the injector 35, as long as the valve device regulates the gas condition on the upstream side and supplies the regulated gas to the downstream side.

Further, the aforesaid embodiment has disclosed the example wherein the asynchronous control according to the present invention is used for supplying the hydrogen gas of the hydrogen gas supply flow path 31; however, the asynchronous injection control according to the present invention is not limited thereto. The asynchronous injection control may be used also for the supply of the oxidizing gas of the oxidizing gas supply flow path 21.

Further, the above embodiments have disclosed the examples wherein the fuel cell system in accordance with the present invention has been mounted in a fuel cell hybrid vehicle. The fuel cell system in accordance with the present invention can be installed also in a variety of moving bodies (e.g., a robot, a ship, aircraft, and the like) in addition to a fuel cell hybrid vehicle. Furthermore, the fuel cell system in accordance with the present invention may be applied also to a fixed power generation system used as power generating equipment for a building (a house, a building, or the like).

1. A fuel cell system comprising:
a fuel cell;
a gas supply flow path for supplying a reactant gas to the fuel cell;
a valve device which is provided in the gas supply flow path and driven at a predetermined drive cycle;
a controller which controls the drive of the valve device such that the reactant gas supplied to the fuel cell reaches a target gas state; and
a sensor which measures the gas state of a reactant gas on a downstream side of the valve device,
wherein the controller opens a valve of the valve device in the middle of the predetermined drive cycle regardless of the drive cycle in the case where the controller detects that the difference between the target gas state and the gas state measured by the sensor has exceeded a predetermined value.

2. The fuel cell system according to claim 1, wherein the controller enables measurement by the sensor after a predetermined time elapses from the instant the valve of the valve device is opened.

3. The fuel cell system according to claim 2, wherein
the controller has a predetermined arithmetic cycle, and
the controller detects whether the difference between the target gas state and the gas state measured by the sensor exceeds a predetermined value at an arithmetic cycle following the elapse of the predetermined time.

4. The fuel cell system according to claim 2, wherein the predetermined time is the time for the gas state on the downstream side of the valve device to stabilize after the valve of the valve device is opened.

5. The fuel cell system according to claim 1, wherein the gas state is the gas pressure of the reactant gas and the sensor is a pressure sensor.

6. The fuel cell system according to claim 1, wherein the valve device is an injector.

7. A moving body comprising the fuel cell system according to claim 1.
